(19) United States
(12) Patent Application Publication
(10) Pub. No.: US 2004/0113485 A1
(43) Pub. Date: Jun. 17, 2004

(54) Master cylinder fiber optic pressure sensor

(75) Inventors: Michael P. Oliver, Beavercreek, OH (US); Connie J. Buynacek, Troy, OH (US)

Correspondence Address: Scott A. McBain, DELPHI TECHNOLOGIES INC., Legal Staff, Mail Code: 480-410-202, P.O. Box 5052, Troy, MI, 48007, US

(73) Assignee: DELPHI TECHNOLOGIES INC.

(21) Appl. No.: 10/318,943

(22) Filed: Dec. 13, 2002

(51) Int. Cl. B60T 13/74

(52) U.S. Cl. 303/3

(57) ABSTRACT

Pressure in a brake master cylinder is sensed. An optical transducer is affixed to a master cylinder housing. A pressure signal is generated by the optical transducer in response to hydraulic pressure in the master cylinder. A vehicle including a system for sensing pressure in a master cylinder is provided. A brake master cylinder having an access point machined into the master cylinder housing to access a hydraulic chamber is provided. An optical pressure transducer is also provided. A transducer mount assembly affixing the transducer to the master cylinder at the access point and a controller operably coupled to the optical pressure transducer are provided.

### TECHNICAL FIELD OF THE INVENTION

This invention relates to vehicle brake systems, and more particularly to provisions for pressure detection in a brake master cylinder.

### BACKGROUND OF THE INVENTION

Vehicles such as automobiles, trucks, buses, and motor homes typically contain a hydraulic brake system including a master cylinder. A master cylinder contains hydraulic fluid typically contained under pressures up to 5000 pounds per square inch, depending on brake pedal force input.

It is a United States federal requirement to provide a fluid level sensor for a brake master cylinder or a pressure sensor in the braking system. The master cylinder fluid level provides an indication of the operational status of the master cylinder. In the event that low fluid level is detected, a warning indicator may then alert a vehicle driver to potential brake system failure. Therefore monitoring brake systems, and particularly a master cylinder is an important safety concern.

Integration of pressure detection in braking systems typically requires resorting to large and expensive mechanical pressure transducers. It is generally not practical to utilize such a pressure detection device within a master cylinder hydraulic chamber because master cylinder function and performance may be compromised. Therefore, it would be desirable to provide an improved system for pressure detection in a braking system that overcomes these and other disadvantages.

### SUMMARY OF THE INVENTION

The present invention is directed to a system and method for an improved vehicle brake master cylinder. The master cylinder system has optical pressure detection. An optical pressure detection assembly is positioned to detect pressure in a hydraulic chamber of a master cylinder without affecting master cylinder function or performance.

In accordance with the invention, a method and system is directed to sensing hydraulic pressure in a master cylinder. Means for optically sensing pressure are provided. Means for affixing the optical sensing means to a master cylinder housing and means for generating a pressure signal coupled to the optical pressure sensing means are also provided.

In accordance with another aspect of the invention, a vehicle including a system for sensing pressure in a master cylinder is provided. A brake master cylinder having an access point machined into the master cylinder housing to access a hydraulic chamber is provided. A pressure transducer is also provided. A transducer mount assembly affixing the transducer to the master cylinder at the access point and a controller operably coupled to the optical pressure transducer are provided.

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 shows an exemplary embodiment of an apparatus for optical pressure detection in a vehicle master cylinder in accordance with the invention;

FIG. 2 shows a pressure transducer assembly in accordance with the invention;

FIG. 3 is a block diagram of a system for optical pressure detection in a master cylinder in accordance with the invention; and

FIG. 4 is a flow diagram of a process for optical pressure detection in a master cylinder in accordance with the invention.

### DETAILED DESCRIPTION OF THE PRESENTLY PREFERRED EMBODIMENTS

Throughout this specification the term “connected” means a direct electrical connection between the things that are connected, without any intermediate devices. The term “coupled” means either a direct electrical connection between the things that are connected or an indirect connection through one or more passive or active intermediary devices such as a bidirectional data bus or the equivalent. Whenever possible, similar elements follow a common numbering convention throughout the figures. The phrase “software module” is any set of computer executable instructions, data structures and the like, or the equivalent reduced to circuits using a high-level description language, that perform a specified function when called to run as a process. In the following system diagrams, many connections to components such as AC or DC power are omitted for clarity. Those skilled in the art will appreciate components requiring power or other connections not essential to the description of the system.

The present invention is directed to a system and method for an improved vehicle brake master cylinder. The master cylinder system has optical pressure detection. An optical pressure detection assembly is positioned to detect pressure in a hydraulic chamber of a master cylinder without affecting master cylinder function or performance.

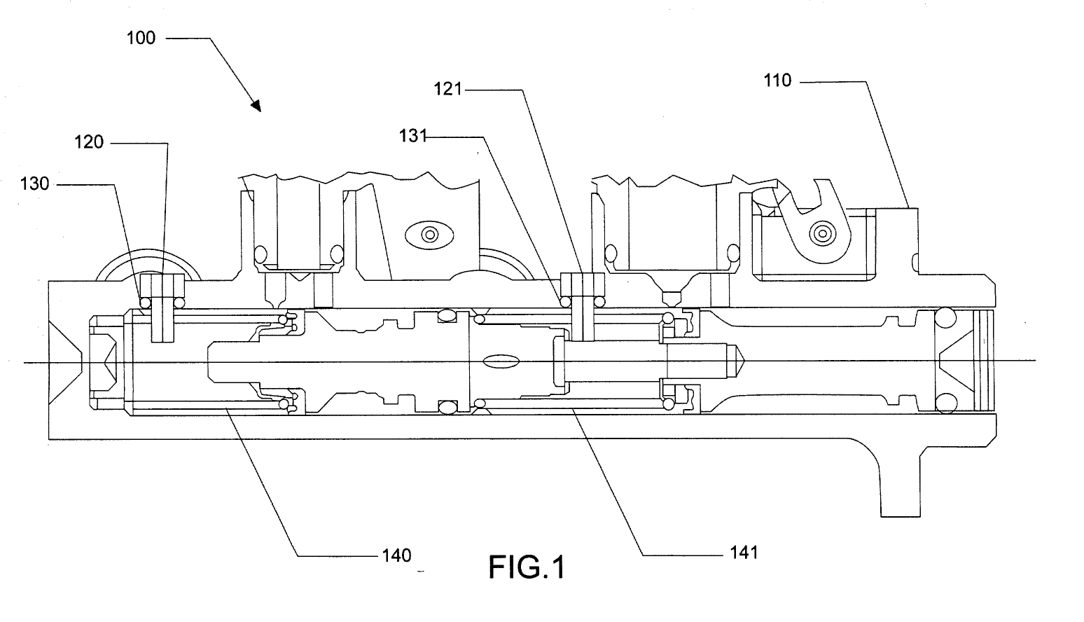

FIG. 1 shows an exemplary embodiment of a vehicle master cylinder with optical pressure detection in accordance with the invention. FIG. 1 shows a master cylinder assembly 100 including optical pressure detection. Components of the master cylinder assembly 100 shown in FIG. 1 include: a master cylinder body 110; a first pressure transducer 120; a first seal 130; a second pressure transducer 121; a second seal 131; a first hydraulic chamber 140; and, a second hydraulic chamber 141. FIG. 1 shows the first pressure transducer 120 and the second pressure transducer 121 fitted to the master cylinder body 110 with the first seal 130 and the second seal 131.

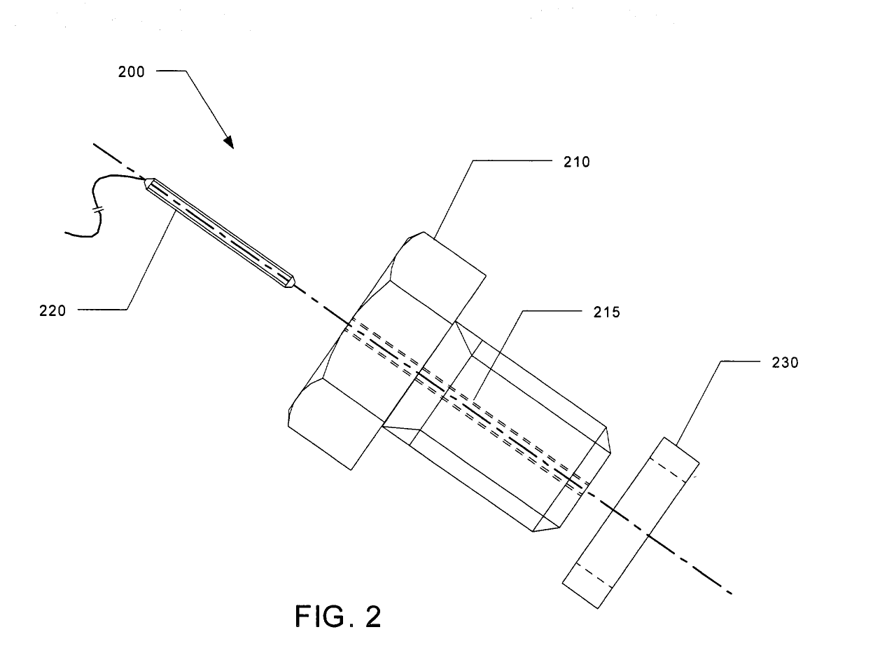

The master cylinder body 110 is generally a cast or machined metal housing for containing a hydraulic brake system. Hydraulic chambers such as the first hydraulic chamber 140 and the second hydraulic chamber 141 are contained in the master cylinder housing 110 to provide hydraulic pressure to a brake line. The present invention provides pressure detection in a hydraulic chamber 140 of the master cylinder assembly 100. The first pressure transducer 120 and the second pressure transducer 121 are positioned such that they do not affect the hydraulic action or performance of the master cylinder assembly 100. A pressure transducer 120 is generally affixed to the master cylinder body 110 through a cast or machined hole in the master cylinder body 110 at a point that provides access to a hydraulic chamber 140. The access point is chosen such that the hydraulic action and performance of the master cylinder is not affected. The access point for the pressure transducer 120 may be placed in any position on the master cylinder body 110 that allows access to a hydraulic chamber (140, 141) and that does not impact the function or performance of the master cylinder assembly. In one embodiment, the access point is tapped with a thread commensurate with the typical hydraulic pressures involved in normal master cylinder operation. The pressure transducer 120 is typically fitted to the tapped access point with a threaded transducer mount assembly such as shown in FIG. 2. One significant advantage of the present invention is the ability to utilize existing master cylinder housings by requiring only a small hole be drilled and tapped in the master cylinder body.

In one embodiment, the pressure transducer 120 is affixed to the master cylinder body 110 via an adhesive. In another embodiment the pressure transducer 140 is affixed to the master cylinder body 110 via a weld. In yet another embodiment, the pressure transducer 120 is affixed to the master cylinder body 110 via an integral casting. Other equivalent methods for affixing the pressure transducer 120 to the master cylinder body 110 may be appreciated by those skilled in the art.

FIG. 2 shows a pressure transducer assembly 200 in accordance with the invention. Components of the pressure transducer assembly 200 shown in FIG. 2 include: a pressure transducer 220; and a transducer mount assembly 210 with a through-centerline cavity 215, and a seal 230. The pressure transducer assembly 200 of FIG. 2 is depicted in exploded view with a centerline through the pressure transducer 220, the transducer mount assembly 210 and the seal 230.

The pressure transducer 220 is an electromechanical or electronic device capable of detecting pressure in a hydraulic cylinder of a master cylinder through a mechanical, electrical or optical process. In one embodiment, the pressure transducer 220 is a strain-gauge device such as a piezo-electric or optical strain gauge. In another embodiment, the pressure transducer 220 is a fiber-optic pressure transducer. Pressure transducer technologies are known in the art and the skilled practitioner will recognize other suitable equivalents for the pressure transducer 220 of FIG. 2.

The transducer mount assembly 210 provides mechanical coupling capability to the pressure transducer 220. In the embodiment depicted in FIG. 2, the transducer mount assembly is a bolt 210 with a drilled out centerline cavity 215 sized to accept the pressure transducer 220. In another embodiment, the transducer mount assembly is a fastener designed to fit within a receptacle of a master cylinder body 110. The transducer mount assembly 210 may be a single element or a composition of elements that provides the essential carrier and mounting functions required of the specific application. Generally, the pressure transducer 220 is positioned into the transducer mount assembly 210 and robustly affixed to form a single unit with high mechanical integrity. An epoxy or other compounds may be used to affix or seal the pressure transducer into the transducer mount assembly 210. The method of affixing and sealing the pressure transducer 220 into the transducer mount assembly 210 must be capable of withstanding normal operating pressures of a master cylinder hydraulic chamber on the order of 5000 psi, and associated temperature differentials due to the high pressures involved.

The seal 230 provides a pressure-sealed coupling between the master cylinder body 110 and the transducer mount assembly as shown in FIG. 1 of seals 130 and 131. The seal is any device capable of providing a robust mechanical seal such as washer, an o-ring, epoxy and the equivalent bonding compounds. In one embodiment the seal is chosen for shock resistance. In another embodiment, the seal is selected for tolerance of large temperature differentials.

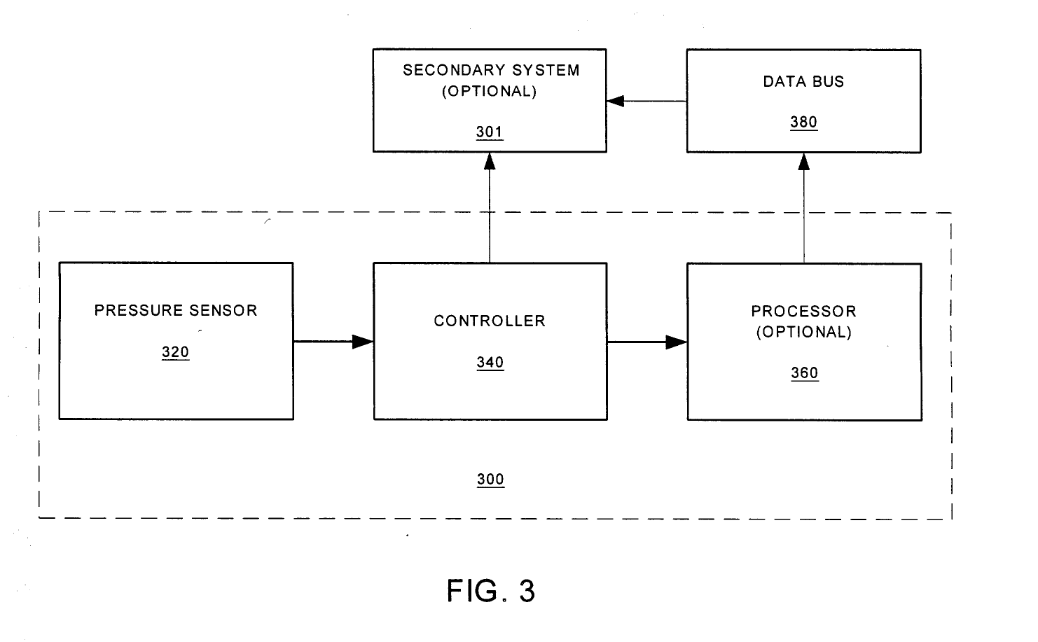

FIG. 3 is a block diagram of a system 300 for optical pressure detection in a master cylinder in accordance with the invention. FIG. 3 shows the pressure detection system 300 containing a sensor 320, a controller 340, and an optional processor 360. In FIG. 3, an optional secondary system 310 and a data bus 380 are also depicted. FIG. 3 shows the pressure sensor 320 coupled to the controller 340. The controller 340 is shown coupled to the optional processor 360. The controller 340 is additionally shown coupled to the optional secondary system 301. The processor 360 is shown coupled to the data bus 380.

The pressure sensor 320 is a sensor such as pressure sensor 120 of FIG. 1 or pressure sensor 220 of FIG. 2. In operation, the pressure sensor 320 typically generates a pressure signal in the form of a voltage or current proportional to a volumetric displacement. The pressure sensor 320 is any device suitable for detecting pressure in a master cylinder hydraulic chamber such as hydraulic chamber 140 of FIG. 1. In one embodiment, the pressure sensor 320 is a fiber-optic pressure sensor that generates an optical signal proportional to a volumetric displacement.

The controller 340 is a device capable of receiving a pressure signal from the pressure sensor and providing the pressure signal to other devices in a compatible form. In one embodiment, the controller 340 receives an optical pressure signal from the pressure sensor 320 and converts the optical pressure signal to a voltage or current signal of an appropriate magnitude for delivery to another device or system such as secondary system 301 or processor 360. In one embodiment, the pressure sensor 320 and the controller 340 are an integrated package.

The optional processor 360 is a device capable of providing computing functions such as signal conversion, filtering or other signal manipulation or interpretation. The processor 360 may be optionally integrated with the controller 340 (not shown). In one embodiment, the processor provides digital-to-analog conversion for a pressure signal provided by the controller 340.

The data bus 380 is an integrated communication system for signals within an automobile. Generally, the data bus is a bidirectional communication path for digitally encoded signals allowing various systems to exchange data. Devices coupled to the data bus 380 generally have unique addresses that allow them to be identified and accessed by other devices. Methods and systems for implementing a data bus 380 will be known by those skilled in the art, and will not be further elaborated. In one embodiment (not shown) the controller 340 is enabled to communicate with the data bus 380. In another embodiment, the optional processor 360 is enabled to communicate with the data bus 380. In yet another embodiment, the data bus 380 is enabled to communicate with a secondary system 301.

A secondary system 301 is a system such as an alert system used to alert an automobile driver of a hazardous condition due to system failure, or an automobile central processor or a software module running on an automobile central processor, for example. A secondary system is any system that is not part of the pressure detection system 300, but that may use data generated by the pressure detection system 300.

### Method for Pressure Detection in a Master Cylinder

Pressure is optically sensed in a master cylinder. A pressure signal is then generated based on the sensed pressure. Additional steps not elucidated may occur within the following description and some steps may be combined, omitted or occur in a different order without departing from the spirit and scope of the invention.

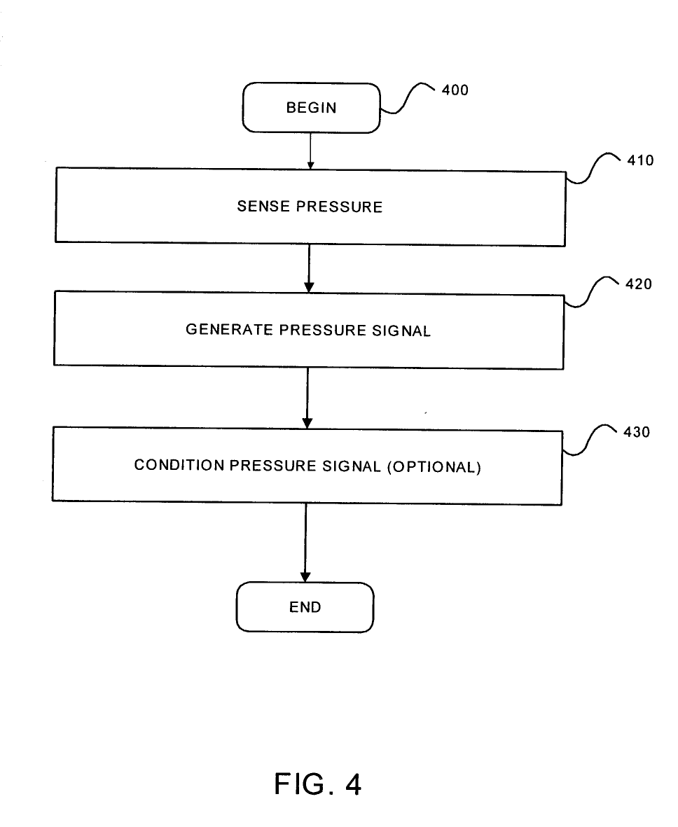

FIG. 4 is a flow diagram of a process for optical pressure detection in a master cylinder in accordance with the invention. Process 400 begins in step 410. In step 410, pressure is sensed in a master cylinder. The pressure is sensed by a pressure transducer such as pressure transducers 120, 220 and 320 of FIGS. 1, 2 and 3 respectively. The pressure may be sensed at any time continuously or at discrete intervals. Generally, the pressure is sensed continuously as pressure in the master cylinder changes. As the pressure is sensed in step 410, an optical signal is provided to a controller, such as controller 340 of FIG. 3. The controller 340 is capable of receiving the optical signal. The optical signal may be provided to the controller at any time continuously or in discrete intervals. Generally, the pressure transducer is coupled to the controller 340 as depicted in FIG. 3.

In step 420, a pressure signal is generated based on the pressure sensed in step 410. The pressure signal may be generated at any time continuously or in discrete intervals. Generally, a controller such as controller 340 of FIG. 3 generates the pressure signal based upon the optical signal provided by the pressure transducer 320. In one embodiment, the pressure signal is the optical output of the pressure transducer. In another embodiment, the pressure signal is a modulated version of the optical output of the pressure transducer. In yet another embodiment, the pressure signal is a voltage or current signal derived from the optical output of the pressure transducer. The pressure signal generated in step 420 is generally in a form that may be provided to another system, such as secondary system 310 of FIG. 3.

In optional step 430, the pressure signal generated in step 420 is conditioned. The signal conditioning may occur at any time continuously or in discrete intervals. The signal conditioning is generally performed by a processing device such as processor 360 of FIG. 3, which is capable of receiving the generated pressure signal. Signal conditioning includes analog-to-digital conversion, filtering, amplification and other processing functions such as signal evaluation or state detection. Generally the conditioned pressure signal is in a form that may be provided to other systems such as data bus 380 or secondary system 301 of FIG. 3.

An example of the system and method of the invention in operation is now provided. However, the following illustrations are merely examples of the manner in which the invention may be practiced and in no way are intended to describe all applications or to cite all known embodiments.

A modem automobile is a wonder of integration. Many automobiles include centralized electronic engine and system management functionality, including extensive diagnostic and safety functions through a vehicle “brain” computer system.

The system and apparatus of the invention is capable of sensing a pressure failure in a vehicle master cylinder. An automobile enabled to detect master cylinder pressure is therefore capable of providing valuable data that could warn a driver of incipient brake system danger. When the master cylinder pressure detection system is enabled to communicate with the automobile central “brain” computer a number of options exist. In one example of the invention in application, an ABS modulator is automatically activated by the vehicle computer to provide a backup braking system as a pressure failure is detected in the master cylinder. In another example, the driver is alerted to a potential brake system failure through dash lighting, audio alarms and the like as pressure failure in the master cylinder is detected by the system of the invention. In yet another example of the invention, an engine management system is directed to cut engine power or to invoke compression braking as a backup brake system as pressure failure in the master cylinder is detected.

The scope of the invention is indicated in the appended claims. We intend that all changes or modifications within the meaning and range of equivalents are embraced by the claims.

We claim:

1. Apparatus for sensing hydraulic pressure in a master cylinder comprising:
a pressure transducer;
a transducer mount assembly for affixing the transducer to the master cylinder; and,
a controller operably coupled to the pressure transducer.

2. The apparatus of claim 1 wherein the pressure transducer is a fiber-optic pressure sensor.

3. The apparatus of claim 1 wherein the controller is integrated with the transducer mount assembly.

4. The apparatus of claim 3 wherein the transducer mount assembly includes a bolt machined through the centerline to house the pressure transducer.

5. The apparatus of claim 3 wherein the transducer mount assembly includes a seal.

6. The apparatus of claim 5 wherein the seal is selected from the group consisting of an o-ring, epoxy and a washer.

7. A brake system including:
a brake master cylinder having an access point machined into the master cylinder housing to access a hydraulic chamber;
a pressure transducer;
a transducer mount assembly affixing the transducer to the master cylinder at the access point; and,
a controller operably coupled to the optical pressure transducer.

8. The brake system of claim 7 wherein the pressure transducer is a fiber optic pressure sensor.

9. The brake system of claim 8 wherein the controller is integrated with the transducer mount assembly.

10. The brake system of claim 8 wherein the transducer mount assembly is a bolt machined through the centerline to house the pressure transducer.

11. The brake system of claim 10 wherein the transducer mount assembly includes a seal.

12. The brake system of claim 11 wherein the seal is selected from the group consisting of an o-ring, epoxy and a washer.

13. Apparatus for sensing hydraulic pressure in a master cylinder comprising:
means for optically sensing pressure;
means for affixing the optical sensing means to a master cylinder housing; and,
means for generating a pressure signal coupled to the optical pressure sensing means.

14. A method for sensing hydraulic pressure in a master cylinder comprising:
sensing pressure optically in a chamber of the master cylinder; and
generating a pressure signal based on the sensed pressure.

15. The method of claim 14 further comprising conditioning the pressure signal.

16. The method of claim 15 wherein conditioning the pressure signal includes converting an optical signal to a voltage signal.

17. The method of claim 15 wherein conditioning the pressure signal includes conversion of a continuous-time signal to a discrete digitally encoded signal.
